(19) United States
(12) Patent Application Publication
(10) Pub. No.: US 2024/0406150 A1
(43) Pub. Date: Dec. 5, 2024

(54) PROTECTING SENSOR DATA

(71) Applicant: Apple Inc., Cupertino, CA (US)

(72) Inventors: D J CAPELIS, San Francisco, CA (US); Benjamin BIRON, Saratoga, CA (US); Jacques FORTIER, San Francisco, CA (US); Peter A. LISHERNESS, Los Gatos, CA (US)

(21) Appl. No.: 18/677,295

(22) Filed: May 29, 2024

Related U.S. Application Data
(60) Provisional application No. 63/470,793, filed on Jun. 2, 2023.

(51) Int. Cl. H04L 9/40

(52) U.S. Cl. CPC H04L 63/0428

(57) ABSTRACT

Some techniques are described herein for providing a secure process to selectively provide different resolutions of sensor information to a system process of an operating system in response to different requests received by the system process from applications. For example, a sensor of a device can provide sensor data to a secure application of the device that performs one or more operations using the sensor data to generate metadata corresponding to the sensor data. In such an example, the secure application can provide the metadata to a filter layer of the device that also receives the sensor data and determines what resolution of the sensor data to send to an application of the device via a system process of an operating system of the device. Other techniques described herein include a filtering step at the system process.

### CROSS-REFERENCE TO RELATED APPLICATIONS

The present application claims priority to U.S. Provisional Patent Application Ser. No. 63/470,793 entitled “PROTECTING SENSOR DATA,” filed Jun. 2, 2023, which is hereby incorporated by reference in its entirety for all purposes.

### BACKGROUND

Electronic devices often include sensors for detecting sensor data. Applications executing on the electronic devices can use such data to perform operations. However, protecting such sensor data during particular periods of time and/or from particular applications can be important. Accordingly, there is a need to improve techniques for protecting sensor data.

### SUMMARY

Some current techniques for protecting sensor data are generally ineffective and/or inefficient. For example, some techniques require specialty hardware to protect such data. Other techniques require a system process of an operating system to protect such data, ignoring the risk of the system process and/or the operating system becoming compromised. This disclosure provides more effective and/or efficient techniques for protecting sensor data using an example of a secure process executing outside of an operating system to filter sensor information to an application via the operating system. It should be recognized that other types of data besides sensor information can be used with techniques described herein. For example, personally-identifiable information can be used with techniques described herein. In addition, techniques optionally complement or replace other techniques for protecting sensor data.

Some techniques are described herein for providing a secure process executing one or more secure applications to selectively provide different resolutions of sensor information (e.g., raw sensor data, subsets of raw sensor data, reduced-resolution versions of sensor data, and/or different resolutions of metadata corresponding to sensor data) to a system process of an operating system in response to different requests received by the system process from applications. For example, one or more sensors of a device can provide sensor data to a secure application of the device that performs one or more operations on the sensor data to generate metadata corresponding to the sensor data. In such an example, the secure application can provide the metadata to a filter layer of the device that also receives the sensor data and determines what resolution of sensor information (e.g., the sensor data and/or the metadata) to send to an application of the device via a system process (e.g., a daemon) of an operating system of the device. In some examples, the filter layer takes into account different criteria including what application is requesting sensor information, what output devices of the device are currently active, what is being displayed, what the sensor information is, what input devices of the device are currently detecting, historical sensor information usage, and/or other criteria described herein. Other techniques described herein include a filtering step at the system process. In such techniques, the system process performs one or more checks that are the same as or similar to the criteria described above before requesting and/or after receiving sensor information from the secure process.

In some examples, a method that is performed by a secure process of a device is described. In some examples, the method comprises: receiving, from a sensor in communication with the secure process, sensor data; and after receiving the sensor data: in accordance with a determination that a first set of one or more criteria is satisfied, wherein the first set of one or more criteria includes a criterion that is satisfied when the device is currently in a first state, sending the sensor data to a system process of the device; and in accordance with a determination that a second set of one or more criteria is satisfied, wherein the second set of one or more criteria includes a criterion that is satisfied when the device is currently in a second state different from the first state, forgoing sending the sensor data to the system process of the device, wherein the second set of one or more criteria is different from the first set of one or more criteria.

In some examples, a non-transitory computer-readable storage medium storing one or more programs configured to be executed by one or more processors of a device is described. In some examples, the one or more programs includes instructions for: receiving, from a sensor in communication with a secure process, sensor data; and after receiving the sensor data: in accordance with a determination that a first set of one or more criteria is satisfied, wherein the first set of one or more criteria includes a criterion that is satisfied when the device is currently in a first state, sending the sensor data to a system process of the device; and in accordance with a determination that a second set of one or more criteria is satisfied, wherein the second set of one or more criteria includes a criterion that is satisfied when the device is currently in a second state different from the first state, forgoing sending the sensor data to the system process of the device, wherein the second set of one or more criteria is different from the first set of one or more criteria.

In some examples, a transitory computer-readable storage medium storing one or more programs configured to be executed by one or more processors of a device is described. In some examples, the one or more programs includes instructions for: receiving, from a sensor in communication with a secure process, sensor data; and after receiving the sensor data: in accordance with a determination that a first set of one or more criteria is satisfied, wherein the first set of one or more criteria includes a criterion that is satisfied when the device is currently in a first state, sending the sensor data to a system process of the device; and in accordance with a determination that a second set of one or more criteria is satisfied, wherein the second set of one or more criteria includes a criterion that is satisfied when the device is currently in a second state different from the first state, forgoing sending the sensor data to the system process of the device, wherein the second set of one or more criteria is different from the first set of one or more criteria.

In some examples, a device is described. In some examples, the device comprises one or more processors and memory storing one or more programs configured to be executed by the one or more processors. In some examples, the one or more programs includes instructions for: receiving, from a sensor in communication with a secure process, sensor data; and after receiving the sensor data: in accordance with a determination that a first set of one or more criteria is satisfied, wherein the first set of one or more criteria includes a criterion that is satisfied when the device is currently in a first state, sending the sensor data to a system process of the device; and in accordance with a determination that a second set of one or more criteria is satisfied, wherein the second set of one or more criteria includes a criterion that is satisfied when the device is currently in a second state different from the first state, forgoing sending the sensor data to the system process of the device, wherein the second set of one or more criteria is different from the first set of one or more criteria.

In some examples, a device is described. In some examples, the device comprises means for performing each of the following steps: receiving, from a sensor in communication with a secure process, sensor data; and after receiving the sensor data: in accordance with a determination that a first set of one or more criteria is satisfied, wherein the first set of one or more criteria includes a criterion that is satisfied when the device is currently in a first state, sending the sensor data to a system process of the device; and in accordance with a determination that a second set of one or more criteria is satisfied, wherein the second set of one or more criteria includes a criterion that is satisfied when the device is currently in a second state different from the first state, forgoing sending the sensor data to the system process of the device, wherein the second set of one or more criteria is different from the first set of one or more criteria.

In some examples, a computer program product is described. In some examples, the computer program product comprises one or more programs configured to be executed by one or more processors of a device. In some examples, the one or more programs include instructions for: receiving, from a sensor in communication with a secure process, sensor data; and after receiving the sensor data: in accordance with a determination that a first set of one or more criteria is satisfied, wherein the first set of one or more criteria includes a criterion that is satisfied when the device is currently in a first state, sending the sensor data to a system process of the device; and in accordance with a determination that a second set of one or more criteria is satisfied, wherein the second set of one or more criteria includes a criterion that is satisfied when the device is currently in a second state different from the first state, forgoing sending the sensor data to the system process of the device, wherein the second set of one or more criteria is different from the first set of one or more criteria.

In some examples, a method that is performed by a system process of a device is described. In some examples, the method comprises: receiving, from an application of the device, a first request for sensor data; in response to receiving the first request for sensor data and in accordance with a determination that a first set of one or more criteria is satisfied, wherein the first set of one or more criteria includes a criterion that is satisfied when the device is in a first state, sending, to a secure process of the device, a second request for sensor data; after sending the second request for sensor data, receiving, from the secure process, sensor information corresponding to the second request; and in response to receiving the sensor information corresponding to the second request, sending the sensor information to the application of the device.

In some examples, a non-transitory computer-readable storage medium storing one or more programs configured to be executed by one or more processors of a device is described. In some examples, the one or more programs includes instructions for: receiving, from an application of the device, a first request for sensor data; in response to receiving the first request for sensor data and in accordance with a determination that a first set of one or more criteria is satisfied, wherein the first set of one or more criteria includes a criterion that is satisfied when the device is in a first state, sending, to a secure process of the device, a second request for sensor data; after sending the second request for sensor data, receiving, from the secure process, sensor information corresponding to the second request; and in response to receiving the sensor information corresponding to the second request, sending the sensor information to the application of the device.

In some examples, a transitory computer-readable storage medium storing one or more programs configured to be executed by one or more processors of a device is described. In some examples, the one or more programs includes instructions for: receiving, from an application of the device, a first request for sensor data; in response to receiving the first request for sensor data and in accordance with a determination that a first set of one or more criteria is satisfied, wherein the first set of one or more criteria includes a criterion that is satisfied when the device is in a first state, sending, to a secure process of the device, a second request for sensor data; after sending the second request for sensor data, receiving, from the secure process, sensor information corresponding to the second request; and in response to receiving the sensor information corresponding to the second request, sending the sensor information to the application of the device.

In some examples, a device is described. In some examples, the device comprises one or more processors and memory storing one or more programs configured to be executed by the one or more processors. In some examples, the one or more programs includes instructions for: receiving, from an application of the device, a first request for sensor data; in response to receiving the first request for sensor data and in accordance with a determination that a first set of one or more criteria is satisfied, wherein the first set of one or more criteria includes a criterion that is satisfied when the device is in a first state, sending, to a secure process of the device, a second request for sensor data; after sending the second request for sensor data, receiving, from the secure process, sensor information corresponding to the second request; and in response to receiving the sensor information corresponding to the second request, sending the sensor information to the application of the device.

In some examples, a device is described. In some examples, the device comprises means for performing each of the following steps: receiving, from an application of the device, a first request for sensor data; in response to receiving the first request for sensor data and in accordance with a determination that a first set of one or more criteria is satisfied, wherein the first set of one or more criteria includes a criterion that is satisfied when the device is in a first state, sending, to a secure process of the device, a second request for sensor data; after sending the second request for sensor data, receiving, from the secure process, sensor information corresponding to the second request; and in response to receiving the sensor information corresponding to the second request, sending the sensor information to the application of the device.

In some examples, a computer program product is described. In some examples, the computer program product comprises one or more programs configured to be executed by one or more processors of a device. In some examples, the one or more programs include instructions for: receiving, from an application of the device, a first request for sensor data; in response to receiving the first request for sensor data and in accordance with a determination that a first set of one or more criteria is satisfied, wherein the first set of one or more criteria includes a criterion that is satisfied when the device is in a first state, sending, to a secure process of the device, a second request for sensor data; after sending the second request for sensor data, receiving, from the secure process, sensor information corresponding to the second request; and in response to receiving the sensor information corresponding to the second request, sending the sensor information to the application of the device.

In some examples, a method that is performed by an application of a device is described. In some examples, the method comprises: sending, to a system process of the device, a first request for sensor data; after sending the first request for sensor data and in accordance with a determination that a first set of one or more criteria is satisfied, receiving, from the system process, metadata corresponding to first sensor data, wherein the metadata corresponds to the second request, wherein the metadata is based on the first sensor data, wherein the first sensor data is accessible to a secure process of the device, and wherein the first sensor data is not accessible to the system process; and in response to receiving the metadata corresponding to the first sensor data, performing an operation based on the metadata.

In some examples, a non-transitory computer-readable storage medium storing one or more programs configured to be executed by one or more processors of a device is described. In some examples, the one or more programs includes instructions for: sending, to a system process of the device, a first request for sensor data; after sending the first request for sensor data and in accordance with a determination that a first set of one or more criteria is satisfied, receiving, from the system process, metadata corresponding to first sensor data, wherein the metadata corresponds to the second request, wherein the metadata is based on the first sensor data, wherein the first sensor data is accessible to a secure process of the device, and wherein the first sensor data is not accessible to the system process; and in response to receiving the metadata corresponding to the first sensor data, performing an operation based on the metadata.

In some examples, a transitory computer-readable storage medium storing one or more programs configured to be executed by one or more processors of a device is described. In some examples, the one or more programs includes instructions for: sending, to a system process of the device, a first request for sensor data; after sending the first request for sensor data and in accordance with a determination that a first set of one or more criteria is satisfied, receiving, from the system process, metadata corresponding to first sensor data, wherein the metadata corresponds to the second request, wherein the metadata is based on the first sensor data, wherein the first sensor data is accessible to a secure process of the device, and wherein the first sensor data is not accessible to the system process; and in response to receiving the metadata corresponding to the first sensor data, performing an operation based on the metadata.

In some examples, a device is described. In some examples, the device comprises one or more processors and memory storing one or more programs configured to be executed by the one or more processors. In some examples, the one or more programs includes instructions for: sending, to a system process of the device, a first request for sensor data; after sending the first request for sensor data and in accordance with a determination that a first set of one or more criteria is satisfied, receiving, from the system process, metadata corresponding to first sensor data, wherein the metadata corresponds to the second request, wherein the metadata is based on the first sensor data, wherein the first sensor data is accessible to a secure process of the device, and wherein the first sensor data is not accessible to the system process; and in response to receiving the metadata corresponding to the first sensor data, performing an operation based on the metadata.

In some examples, a device is described. In some examples, the device comprises means for performing each of the following steps: sending, to a system process of the device, a first request for sensor data; after sending the first request for sensor data and in accordance with a determination that a first set of one or more criteria is satisfied, receiving, from the system process, metadata corresponding to first sensor data, wherein the metadata corresponds to the second request, wherein the metadata is based on the first sensor data, wherein the first sensor data is accessible to a secure process of the device, and wherein the first sensor data is not accessible to the system process; and in response to receiving the metadata corresponding to the first sensor data, performing an operation based on the metadata.

In some examples, a computer program product is described. In some examples, the computer program product comprises one or more programs configured to be executed by one or more processors of a device. In some examples, the one or more programs include instructions for: sending, to a system process of the device, a first request for sensor data; after sending the first request for sensor data and in accordance with a determination that a first set of one or more criteria is satisfied, receiving, from the system process, metadata corresponding to first sensor data, wherein the metadata corresponds to the second request, wherein the metadata is based on the first sensor data, wherein the first sensor data is accessible to a secure process of the device, and wherein the first sensor data is not accessible to the system process; and in response to receiving the metadata corresponding to the first sensor data, performing an operation based on the metadata.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described examples, reference should be made to the Detailed Description below, in conjunction with the following drawings in which like reference numerals refer to corresponding parts throughout the figures.

FIG. 1 is a block diagram illustrating a compute system in accordance with some examples.

FIG. 2 is a block diagram illustrating a device with interconnected subsystems in accordance with some examples.

FIG. 3 is a block diagram illustrating a software architecture of a device in accordance with some examples.

FIGS. 4A-4C are block diagrams illustrating flow of data between sensors and an application of a device in accordance with some examples.

FIG. 5 is a flow diagram illustrating a method for a secure process to filter sensor data in accordance with some examples.

FIG. 6 is a flow diagram illustrating a method for a system process to filter sensor data in accordance with some examples.

FIG. 7 is a flow diagram illustrating a method for an application to request sensor data in accordance with some examples.

### DETAILED DESCRIPTION

The following description sets forth exemplary methods, parameters, and the like. It should be recognized, however, that such description is not intended as a limitation on the scope of the present disclosure but is instead provided as a description of exemplary examples.

Methods and/or processes described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described examples. In some examples, the first subsystem and the second subsystem are two separate references to the same subsystem. In some examples, the first subsystem and the second subsystem are both subsystems, but they are not the same subsystem or the same type of subsystem.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

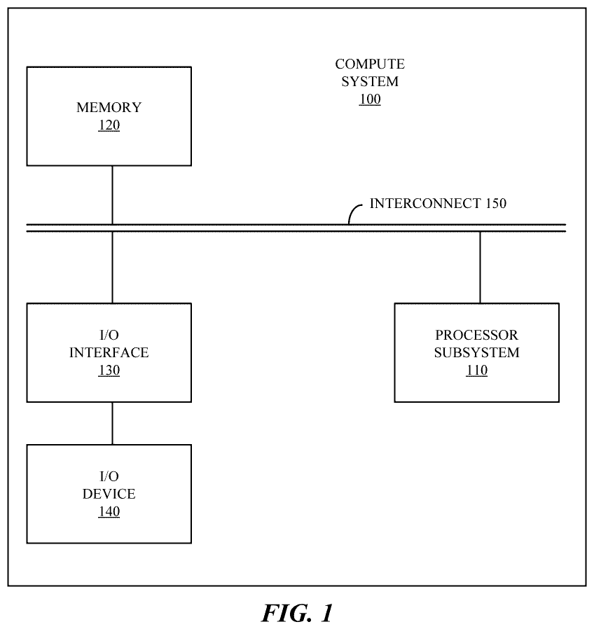

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some examples, I/O interface 130 is included with I/O device 140 such that the two are a single component. It should be recognized that there can be one or more I/O interfaces, with each I/O interface communicating with one or more I/O devices. In some examples, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included or communicating with a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready.

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some examples, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

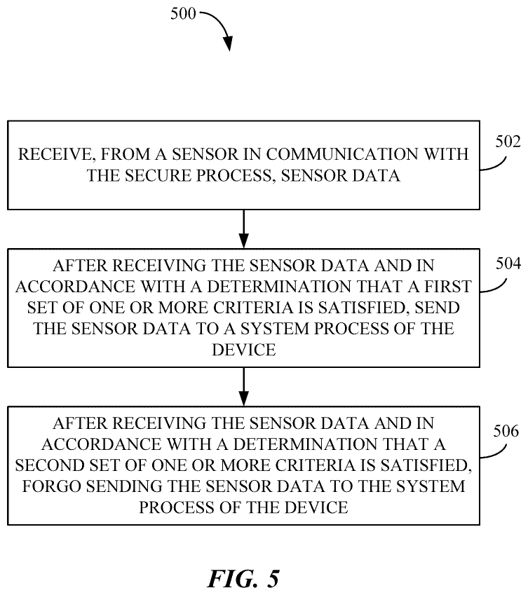

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 500, 600, and 700 (FIGS. 5, 6, and 7) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to communicate with other devices. In some examples, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is communicating with a network via a network interface device (e.g., configured to communicate over Wi-Fi, Bluetooth, Ethernet, or the like). In some examples, compute system 100 is directly or wired to the network.

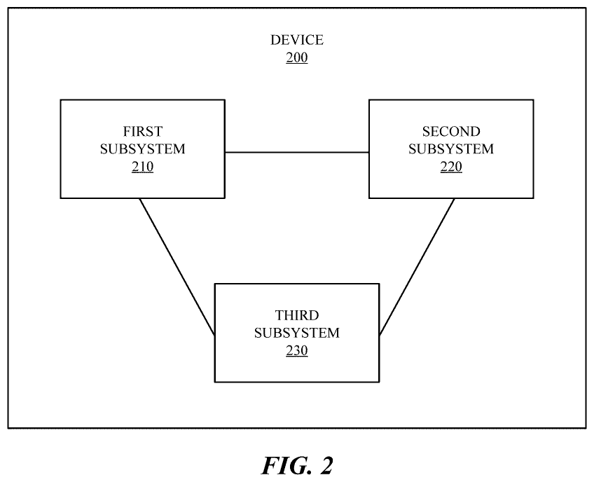

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some examples, at least a portion of device 200 functions as a distributed compute system. For example, a task can be split into different portions, where a first portion is executed by first subsystem 210 and a second portion is executed by second subsystem 220.

As used herein, an “installed application” refers to a software application that has been downloaded onto a computer system (e.g., compute system 100 and/or device 200) and is ready to be launched (e.g., become opened) on the device. In some examples, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of a system/global internal state and/or an application internal state). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards techniques for protecting sensor data. Such techniques are described in the context of an electronic device executing multiple operating systems. It should be recognized that other types of electronic devices can be used with techniques described herein. For example, an electronic device executing a single operating system with a filtering layer outside of the operating system but not inside of another operating system can use techniques described herein. In addition, techniques optionally complement or replace other techniques for protecting sensor data.

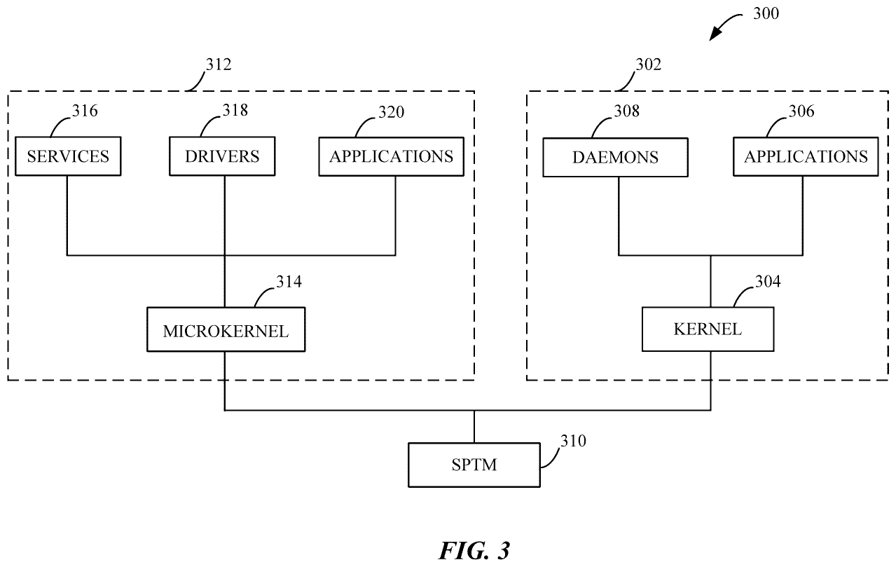

FIG. 3 is a block diagram illustrating a software architecture of a device (e.g., device 300) in accordance with some examples. While not intended to be limiting, device 300 can include one or more components described above with respect to compute system 100 and/or device 200. Examples of device 300 include a smart phone, a smart watch, a fitness tracking device, a wearable device, a head-mounted display, a laptop, a desktop, a tablet, a server, and/or a vehicle.

As illustrated, device 300 includes two operating systems (e.g., first operating system 302 and second operating system 312). In some examples, an operating system, after being initially loaded into device 300 by a boot program, manages processes and/or applications executing on device 300. In examples with multiple operating systems, each operating system manages its own processes and/or applications. It should be recognized that more or fewer operating systems can be included in device 300 and perform techniques described herein.

As illustrated in FIG. 3, first operating system 302 includes kernel 304, applications 306, and daemons 308. In some examples, kernel 304 is a portion of first operating system 302 that is maintained in memory corresponding to first operating system 302 and/or facilitates interactions between software and hardware components corresponding to first operating system 302. For example, kernel 304 can control hardware resources (e.g., I/O devices and/or memory) via device drivers, arbitrate conflicts between processes concerning such resources, and/or optimize utilization of common resources (e.g., CPU and/or cache usage, file systems, and/or network sockets). In some examples, applications 306 includes programs that are run by a user to perform a specific task or service. In some examples, daemons 308 include background processes that are run by kernel 304 to perform a specific task or service for applications 306, kernel 304, and/or first operating system 302. In some examples, first operating system 302 is executing on a first virtual machine.

As illustrated in FIG. 3, second operating system 312 includes microkernel 314, services 316, drivers 318, and applications 320. Similar to kernel 304, in some examples, microkernel 314 is a portion of second operating system 312 that is maintained in memory corresponding to second operating system 312 and/or facilitates interactions between software and hardware components corresponding to first operating system 302. In some examples, microkernel 314 provides less functionality as compared to kernel 304. For example, microkernel 314 can support process scheduling while other services, such as memory management and drivers to interact with hardware, can be supported by other processes (e.g., services 316 and drivers 318). In some examples, applications 320 includes programs that are run via second operating system 312 to perform a specific task or service. In some examples, second operating system 312 is executing on a second virtual machine different from the first virtual machine.

As mentioned above, each of the two operating systems includes a kernel (e.g., kernel 304 for first operating system 302 and microkernel 314 for second operating system 312). It should be recognized that the use of the terms “kernel” and “microkernel” is used for exemplary purposes and either or both could be a different type of kernel in some examples described herein. For example, microkernel 314 and/or kernel 304 can be a monolithic kernel, a microkernel, a hybrid kernel, a nano kernel, or an exo kernel.

In some examples, the two operating systems of device 300 described above operate at least partially independently from each other, though both using an overlapping portion of resources of device 300 (e.g., one or more processors, memory, I/O devices, and/or I/O interfaces). In some examples, first operating system 302 operates in a normal execution mode, including execution of one or more applications (e.g., applications 306) installed and/or stored on device 300. In some examples, the one or more applications are unable to directly communicate with second operating system 312 (e.g., and/or a component of second operation system 312) and instead communicate with second operating system 312 via one or more system processes of first operating system 302, such as kernel 304 of first operating system 302 and/or a daemon of daemons 308 of first operating system 302.

In some examples, the two operating systems of device 300 described above are separated and/or isolated from each other via an isolation manager. The isolation manager manages interactions between the two operating systems (e.g., first operating system 302 and second operating system 312). For example, the isolation manager can provide portions of memory and/or access to processors for an operating system during execution. For another example, the isolation manager can provide an interface for the two operating system to communicate with each other. In some examples, the isolation manager identifies what executes in a guarded mode and what executes in a regular execution mode and provides access to particular resources based on which mode is currently being used. As illustrated in FIG. 3, an example of the isolation manager is a secure page table monitor (e.g., SPTM 310). In some examples, SPTM 310 is in communication with first operating system 302 (e.g., via kernel 304 and/or a different process of first operating system 302) and second operating system 312 (e.g., via microkernel 314 and/or a different process of second operating system 312). In such examples, SPTM 310 can be used by first operating system 302 and/or second operating system 312 to receive identification of (e.g., assignment of) and/or access memory of device 300. It should be recognized that other types of components can be used to provide separation and/or isolation for the two operating systems. For example, any type of hypervisor can be used to provide separation and/or isolation for the two operating systems.

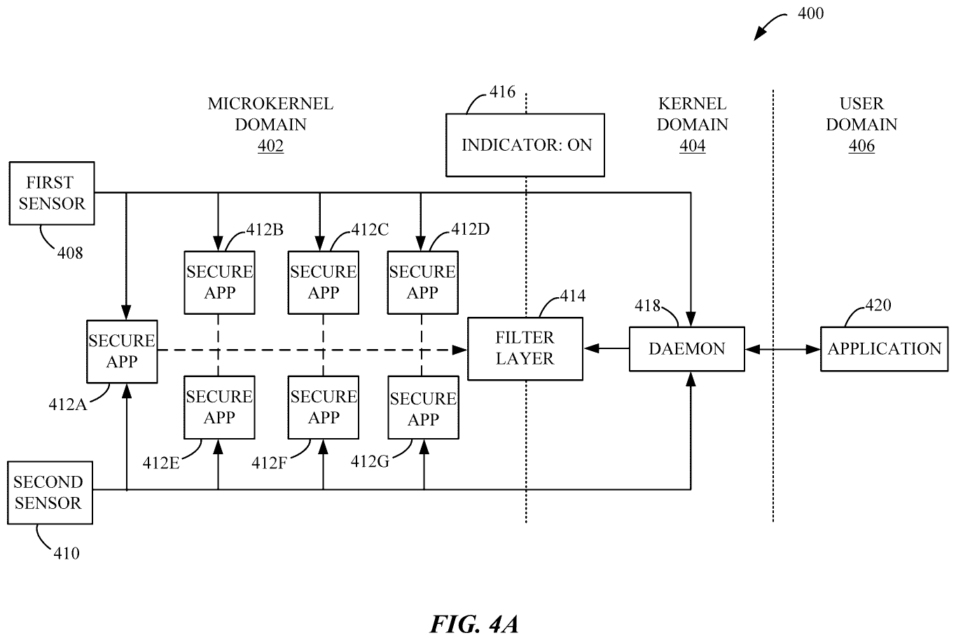

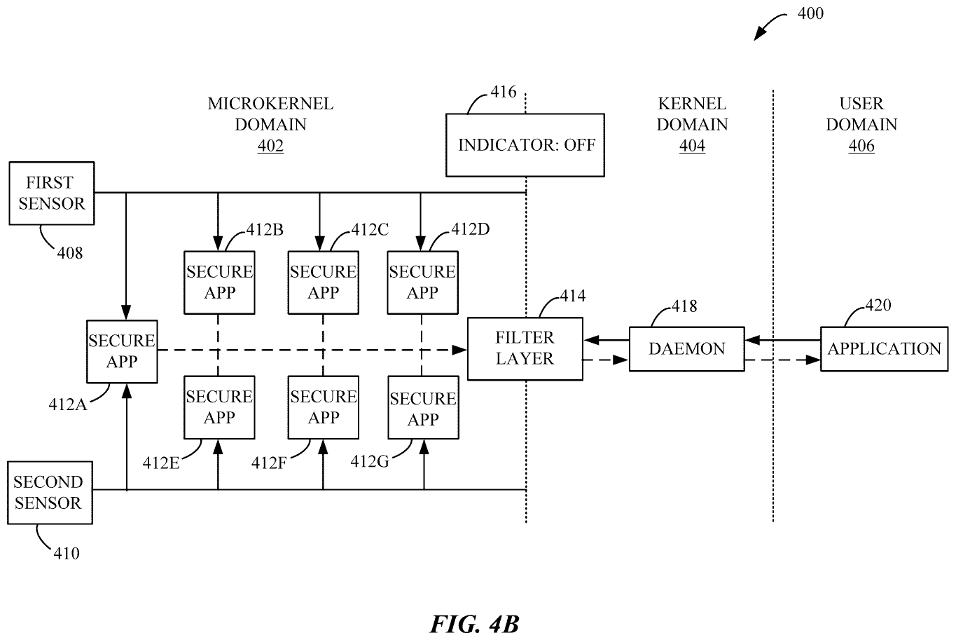

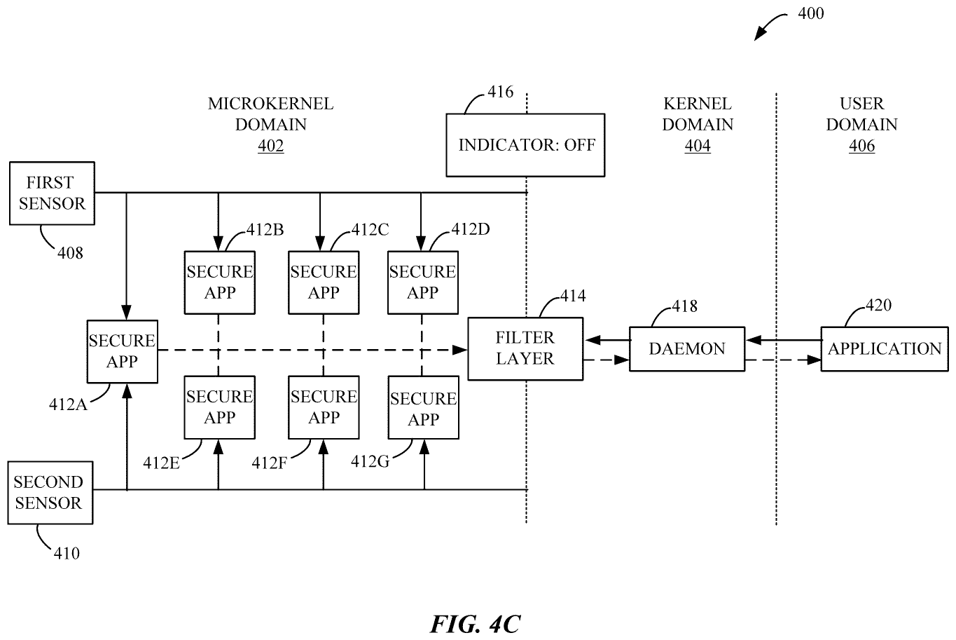

FIGS. 4A-4C are block diagrams illustrating flow of data between sensors (e.g., first sensor 408 and/or second sensor 410) and an application (e.g., application 420) of a device (e.g., device 400) in accordance with some examples. Each of the block diagrams of FIGS. 4A-4C are separated into three domains: microkernel domain 402, kernel domain 404, and user domain 406. In some examples, microkernel domain 402 corresponds to operations managed and/or performed in a guarded mode, such as performed by second operating system 312 in FIG. 3. In some examples, kernel domain 404 corresponds to operations managed and/or performed by a system component of first operating system 302 in FIG. 3 (e.g., a process of kernel 304 and/or a daemon of daemons 308). In some examples, user domain 406 corresponds to operations managed and/or performed by an application (e.g., a non-system process) of first operating system 302 in FIG. 3 (e.g., an application of applications 306). In some examples, kernel domain 404 and/or user domain 406 operate in a regular execution mode, as opposed to a guarded mode described above with respect to microkernel domain 402.

FIG. 4A is a block diagram illustrating flow of sensor data from one or more sensors (e.g., first sensor 408 and/or second sensor 410) through a filter layer (e.g., filter layer 414) and a daemon (e.g., daemon 418) to an application (e.g., application 420).

As mentioned above, in some examples, first sensor 408 and/or second sensor 410 include a microphone, a touch-sensitive surface, a camera, a heart rate monitor, a step counter, a depth sensor, a motion sensor, a magnetic sensor, and/or a gyroscope. For example, first sensor 408 can be a camera, and application 420 can be a photo application that is requesting an image from first sensor 408 via daemon 418 and filter layer 414. In such an example, daemon 418 and/or filter layer 414 can determine whether indicator 416 is on (e.g., active) before allowing the request to be fulfilled (and, in some examples, the request would not be fulfilled when indicator 416 is not on).

At FIG. 4A, the flow includes application 420 sending a request for sensor information (e.g., sensor data and/or metadata corresponding to sensor data) to daemon 418. In some examples, after daemon 418 receives the request, daemon 418 determines a current context of device 400 (e.g., a location of device 400, what an output device in communication with device 400 is currently outputting, whether an output device in communication with device 400 is currently outputting, what an input device in communication with device 400 is currently detecting, whether an input device in communication with device 400 is currently detecting, what processes and/or applications are currently executing on device 400, whether a process and/or application is currently executing on device 400, whether a process and/or application is currently a background or foreground process on device 400, whether device 400 is currently in communication with another device and/or a particular device different from device 400, what a sensor in communication with output device 400 is currently detecting, whether a particular sensor in communication with output device 400 is currently detecting sensor data, and/or a current time of day) and, based on the current context, determines what type of data to request and/or whether to request sensor information from filter layer 414 (e.g., different contexts can cause different types of data to be requested or different types of data can cause daemon 418 to either send or not send a request for sensor information to filter layer 414). For example, daemon 418 can determine whether indicator 416 is on (e.g., active) (e.g., the current context of device 400) and, in response to determining that indicator 416 is on, send a request for sensor information to filter layer 414. In some examples, the request for sensor information includes an indication of a sensor, a type of sensor, and/or a type of sensor information being requested. For example, the request for sensor information can include a request for an image from a camera. In other examples, daemon 418 sends the request for sensor information to filter layer 414 without determining the current context of device 400, leaving such determinations to filter layer 414.

At FIG. 4A, first sensor 408 and second sensor 410 detect (e.g., before, after, and/or as a result of the request for sensor information) sensor data and send the sensor data to one or more secure applications (e.g., secure applications 412A-412G). As illustrated in FIG. 4A, first sensor 408 sends sensor data to secure applications 412A-412D and second sensor 410 sends sensor data to secure applications 412A and 412E-412G. To note, secure application 412A receives sensor data from both first sensor 408 and second sensor 410 while secure application 412B receives sensor data from first sensor 408 but not second sensor 410. It should be recognized that one or more secure applications can receive sensor data from more or fewer sensors, including from only a single sensor, from a different sensor than illustrated in FIG. 4A, or from three or more sensors. It should also be recognized that a secure application can execute in any component of second operating system 312, such as an application of applications 320, a driver of drivers 318, a service of services 316 and/or a component of microkernel 314.

In some examples, sensor data received by a secure application is detected at different times and/or the same time. For example, first sensor 408 can detect first sensor data and send the first sensor data to secure application 412A while second sensor 410 can detect second sensor data after the first sensor data is detected and send the second sensor data to secure application 412A.

In some examples, a secure application (e.g., secure applications 412A-412G) receives sensor data and performs one or more operations, determinations, and/or calculations using the sensor data. For example, the secure application can determine whether sensor data exceeds a threshold (e.g., a predefined threshold stored and/or configured for the secure application, such as an amount of light, an amount of sound, a particular person in an image, a number of people in an image, a number of heart beats, and/or whether an irregular heart beat is present) and output a positive or negative indication (sometimes referred to as metadata herein) based on whether the sensor data exceeded the threshold. In such an example, the positive or negative indication can be sent to another secure application (e.g., secure applications 412B-412D and/or secure applications 412E-412G) and/or filter layer 414.

In some examples, the one or more operations, determinations, and/or calculations are provided to and/or set for the secure application (e.g., by a developer and/or process (e.g., executing in microkernel domain 402) associated with the secure application) before or after the secure application initiates execution. For example, the secure application can include an interface description language (IDL) that defines how a component (e.g., daemon 418 and/or application 420) is able to interact with the secure application via filter layer 414. In some examples, the IDL for the secure application defines a message and/or request that is used to interact with the secure application. For example, the IDL can define that a component can request whether the sensor data exceeds the threshold, limiting interactions with the secure application to whether the sensor data exceeds the threshold, and not allowing other types of interactions. In some examples, an IDL for a secure application can include an inter-process communication (IPC) address for the secure application, such that communications to the secure application use the IPC communication.

As mentioned above, the secure application can output data (e.g., sometimes referred to as metadata corresponding to sensor data) and send to another secure application and/or filter layer 414. In some examples, the other secure application receives metadata from the secure application and also sensor data from a sensor (e.g., first sensor 408 and/or second sensor 410) and performs one or more operations, determinations, and/or calculations based on the metadata and the sensor data to output its own metadata to be sent to another secure application and/or filter layer 414.

At FIG. 4A, filter layer 414 receives metadata from one or more secure applications and sensor data from one or more sensors (e.g., collectively referred to as sensor information) and determines what to output outside of filter layer 414. In some examples, filter layer 414 executes within microkernel domain 402 (e.g., as a service of services 316, an application of applications 320, or as part of microkernel 314), within kernel domain 404 (e.g., as a daemon of daemons 308, as part of kernel 304, or as a system process of kernel 304), or outside of microkernel domain 402 and kernel domain 404. In some examples, filter layer 414 acts as a gateway for sensor information from microkernel domain 402 to kernel domain 404. In some examples, filter layer 414 restricts access to sensor information from a component in kernel domain 404 and/or user domain 406. For example, filter layer 414 can allow a camera to operate as a light sensor and/or motion sensor without providing images to daemon 418 by receiving metadata from a secure application indicating whether light or motion is present and, then, providing the metadata to daemon 418 instead of an image (e.g., the images and/or any image).

In some examples, filter layer 414 determines a current context of device 400 and, based on the current context, determines what to output to daemon 418. For example, filter layer 414 can determine whether indicator 416 is on (e.g., active) and, in response to determining that indicator 416 is on, output sensor data (e.g., as illustrated in FIG. 4A) instead of metadata corresponding to the sensor data (e.g., as illustrated in FIG. 4B and discussed further below) as a response to the request for sensor information from daemon 418 discussed above. In some examples, similar or the same as described above with respect to filter layer 414, daemon 418 determines a current context of device 400 and, based on the current context, determines what to output to application 420. In other examples, daemon 418 outputs what it received from filter layer 414 to application 420 without any determination of the current context.

As described above, filter layer 414 and/or daemon 418 can determine a current context of device 400. In some examples, as part of determining the current context of device 400, filter layer 414 and/or daemon 418 sends a request to change a state of device 400 to cause the current context of device 400 to satisfy a set of criteria needed for processing a request. For example, when indicator 416 must be on (e.g., the set of criteria includes a criterion that is satisfied when indicator 416 is on), filter layer 414 and/or daemon 418 can send a request to cause indicator 416 to be on before continuing with a current request. Accordingly, if the request to cause indicator 416 is successful, the current request can be processed without needing to change what type of data is provided as a response.

In some examples, the sensor data provided to daemon 418 and to application 420 is a different resolution than detected by a sensor (e.g., first sensor 408 and/or second sensor 410). In such examples, filter layer 414 determines, based on the current context of device 400, what resolution of sensor data to send to daemon 418 and/or application 420. In some examples, based on the determined resolution, filter layer 414 sends sensor data with that resolution to daemon 418. For example, the sensor can provide images at a rate of 1 per millisecond while filter layer 414 and/or daemon 418 can provide images at a rate of 1 per second (e.g., a lower resolution than 1 per millisecond).

FIG. 4B is a block diagram illustrating flow of sensor data from one or more sensors (e.g., first sensor 408 and/or second sensor 410) to one or more secure applications (e.g., secure applications 412A-412G) and metadata from the one or more secure applications to a filter layer (e.g., filter layer 414), a daemon (e.g., daemon 418), and then to an application (e.g., application 420).

As described above with respect to FIG. 4A, FIG. 4B illustrates first sensor 408 and second sensor 410 sending sensor data to secure applications 412A-412G and filter layer 414, and secure applications 412A-412G sending metadata to filter layer 414. However, rather than filter layer 414 sending sensor data to daemon 418 as illustrated in FIG. 4A, filter layer 414 sends metadata to daemon 418.

In some examples, the metadata is sent to daemon 418 in response to a request for the metadata from daemon 418 (e.g., daemon 418 either received a request for the metadata from application 420 or daemon 418 determined that a current context of device 400 requires metadata to be provided instead of sensor data). In other examples, the metadata is sent to daemon 418 in response to a request for sensor information (e.g., sensor data and/or metadata) from daemon 418 (e.g., daemon 418 either received a request for sensor information, sensor data, or metadata from application 420 or daemon 418 determined that a current context of device 400 requires filter layer 414 to determine what to send to daemon 418 as a response). As illustrated in FIG. 4B, indicator 416 is off (e.g., inactive) as opposed to on (e.g., as illustrated in FIG. 4A). In some examples, indicator 416 being off causes metadata to be sent to daemon 418 rather than sensor data.

While described as metadata above, it should be recognized that metadata can have different resolutions (e.g., can include different amounts of data and/or specificity). In some examples, filter layer 414 determines, based on the current context of device 400, what resolution of metadata to send to daemon 418 and/or application 420 and, based on the determined resolution, sends metadata with that resolution to daemon 418. For example, filter layer 414 can receive a first indication that a particular person is detected in an image and a second indication that there is a person present in an environment (e.g., the particular person is identified in the first indication and not the second indication). In such an example, filter layer 414 can provide either the first indication (e.g., a higher resolution than the second indication because the particular person is identified) or the second indication (e.g., a lower resolution than the first indication because the particular person is not identified) to daemon 418 depending on the current context of device 300 and/or what application is requesting such information.

FIG. 4C is a block diagram illustrating flow of sensor data from one or more sensors (e.g., first sensor 408 and/or second sensor 410) to one or more secure applications (e.g., secure applications 412A-412G) and a filter layer (e.g., filter layer 414), metadata from the one or more secure applications to the filter layer, and neither the metadata or the sensor data to a daemon (e.g., daemon 418) and an application (e.g., application 420).

As described above with respect to FIGS. 4A-4B, FIG. 4C illustrates first sensor 408 and second sensor 410 sending sensor data to secure applications 412A-412G and filter layer 414, and secure applications 412A-412G sending metadata to filter layer 414. However, rather than filter layer 414 sending sensor data (e.g., as illustrated in FIG. 4A) or metadata (e.g., as illustrated in FIG. 4B) to daemon 418, filter layer 414 sends data to daemon 418 indicative that sensor data and metadata cannot be sent based on a current context of device 400.

In some examples, the data is sent to daemon 418 in response to a request for sensor information (e.g., sensor data and/or metadata) from daemon 418 (e.g., daemon either received a request for sensor information, sensor data, or sensor metadata from application 420 or daemon 418 determined that a current context of device 400 requires filter layer 414 to determine what to send to daemon 418 as a response). As illustrated in FIG. 4C, indicator 416 is off (e.g., inactive). In some examples, indicator 416 being off causes the data to be sent to daemon 418 rather than sensor data or metadata. It should be recognized that other context can cause filter layer 414 to send sensor data of different resolutions, metadata of different resolutions, or neither to daemon 418.

It should be recognized that, while FIGS. 4A-4C illustrate a single application (e.g., application 420) interacting with filter layer 414 via daemon 418, different applications (e.g., of the same type or different type) can communicate with filter layer 414 via daemon 418 (or another daemon) via the same operations with the same or different criteria as described above with respect to application 420. For example, filter layer 414 and/or daemon 418 can have different criteria for different applications and/or different types of applications when determining how to respond to a request.

FIG. 5 is a flow diagram illustrating a method (e.g., method 500) for a secure process to filter sensor data in accordance with some examples. Some operations in method 500 are, optionally, combined, the orders of some operations are, optionally, changed, and some operations are, optionally, omitted.

In some examples, method 500 is performed by a secure process (e.g., drivers 318, applications 320, secure application 412A-412G, and/or filter layer 414) (e.g., a process that limits view of and/or interactions with operations, variables and/or other data related to the secure process) of a device (e.g., compute system 100, device 200, device 300, and/or device 400) (e.g., a mobile device (such as a smartphone, a smart watch, a tablet, a laptop, a wearable device, and/or a head-mounted display), a camera, a television, and/or a microphone). In some examples, the secure process is executed by a CPU (e.g., processor subsystem 110) of the device. In some examples, the secure process is executed by a processor (e.g., processor subsystem 110) executing a user application (e.g., applications 306) of the device. In some examples, data corresponding to the secure process is stored in memory (e.g., memory 120) that also stores data unrelated to the secure process.

At 502, the secure process of the device receives, from a sensor (e.g., first sensor 408 and/or second sensor 410) (e.g., a microphone, a camera, a heartrate monitor, a pedometer, and/or a gyroscope) in communication with the secure process, sensor data (e.g., illustrated in FIGS. 4A-4C as (1) line between first sensor 408 and secure applications 412A-412D and (2) line between second sensor 410 and secure applications 412A and 412E-412G) (e.g., a window of sensor data, sensor data at a point in time, a portion of a stream of sensor data, a sample of a stream of sensor data, raw sensor data, compressed sensor data, summary sensor data, a portion of sensor data, a result of applying one or more mathematical operations (e.g., average, mean, and/or medium) to sensor data, reduced resolution sensor data, combined sensor data, an image, a video, an audio recording, a gyroscope data, and/or a health measurement (e.g., a heart rate measurement, a walking speed measurement, a distance measurement, a breathing measurement, and/or one or more other measurements concerning one or more body parts, health functions, and/or body functions)). In some examples, the sensor is in communication with the device. In some examples, the device includes the sensor.

At 504, after (e.g., directly after, in response to, in conjunction with, while, and/or immediately after) receiving the sensor data and in accordance with a determination that a first set of one or more criteria is satisfied, wherein the first set of one or more criteria includes a criterion that is satisfied when (e.g., a determination is made that) the device is currently in a first state (e.g., a configuration and/or a context) (e.g., whether a visual indicator (e.g., 416) indicates that the sensor data is being used and/or a setting is on), the secure process of the device sends (e.g., as illustrated in FIG. 4A) the sensor data to a system process (e.g., daemons 308 and/or daemon 418) (e.g., a daemon of an operating system and/or a different type of process of an operating system (e.g., a process of the operating system)) of the device.

At 506, after receiving the sensor data and in accordance with a determination that a second set of one or more criteria is satisfied, wherein the second set of one or more criteria includes a criterion that is satisfied when (e.g., a determination is made that) the device is currently in a second state (e.g., not in the first state) different from the first state, the secure process of the device forgoes sending (e.g., as illustrated in FIGS. 4B-4C) the sensor data to the system process of the device, wherein the second set of one or more criteria is different from the first set of one or more criteria. In some examples, after receiving the sensor data and in accordance with a determination that the device is in the second state, the secure process forgoes sending the sensor data anywhere (e.g., to any other process) and instead stores or deletes the sensor data from memory corresponding to the secure process. In some examples, the second state does not include the first state and the first state does not include the second state.

In some examples, the secure process of the device determines (e.g., by the secure process) (e.g., before receiving the sensor data, before sending the sensor data to the system process, and/or before forgoing sending the sensor data to the system process) (e.g., after receiving a request, from the system process, for the sensor data) a current state (e.g., the first state, the second state, and/or another state) of the device. In some examples, the secure process determines the current state of the device by sending a request to an operating system of the device for the current state of the operating system. In some examples, the secure process determines the current state of the device by accessing memory of the device. In some examples, the secure process determines the current state of the device by sending a request to a component (e.g., a user interface component managing whether output is currently being produced) of the device, the component corresponding to and/or associated with the current state of the device corresponding to the first set and/or the second set of one or more criteria.

In some examples, in response to determining the current state of the device (e.g., after receiving the sensor data (e.g., and/or, in some examples, after receiving a request for the sensor data) (and/or before the determination that the first set of one or more criteria and/or the second set of one or more criteria is satisfied)), the secure process of the device sends a request to change the device (e.g., the secure process attempts to cause the device to change) (e.g., the secure process causes the device to change) from a respective state (e.g., the second state or another state different from the first and second state) to the first state. In some examples, after (and/or when, at the same time, because of, as a result of, and/or immediately after) the request to change the device is successful, the criterion of the first set of one or more criteria is satisfied. In some examples, after (and/or when, at the same time, because of, as a result of, and/or immediately after) the request to change the device is not successful, the criterion of the first set of one or more criteria is not satisfied. In some examples, the request to change the device to the first state is sent in response to a determination that the device is currently in a state different from the first state (e.g., the respective state).

In some examples, after receiving the sensor data and in accordance with a determination that the second set of one or more criteria is satisfied (e.g., and/or, in some examples, in accordance with a determination that the first set of one or more criteria is not satisfied), the secure process of the device sends, to the system process, metadata corresponding to the sensor data (e.g., sensor information that is determined, generated, and/or identified from the sensor data) (e.g., metadata includes data about, related to, indicative of, corresponding to, and/or associated with the sensor data). In some examples, the metadata is different from the sensor data. In some examples, the metadata is sent to the system process in response to and/or as a result of a request from the system process for sensor information (e.g., and/or in accordance with a determination that the second set of one or more criteria is satisfied at the time of sending). In some examples, the metadata corresponding to the sensor data is a different (e.g., lower or higher) fidelity and/or resolution than the sensor data such that the system process does not receive all and/or most of the information provided by the sensor data when receiving the metadata instead of the sensor data.

In some examples, after receiving the sensor data and in accordance with a determination that a third set of one or more criteria is satisfied (e.g., and/or, in some examples, in accordance with a determination that the first set of one or more criteria and/or the second set of one or more criteria is not satisfied), the secure process of the device sends, to the system process, second metadata corresponding to the sensor data (e.g., sensor information that is determined, generated, and/or identified from the sensor data), wherein the second metadata is different from the sensor data and the metadata (e.g., and, in some examples, the metadata is first metadata). In some examples, the third set of one or more criteria includes a criterion that is satisfied when the device is in the second state. In some examples, the second set of one or more criteria includes a criterion that is satisfied when sensor information (e.g., sensor data and/or metadata corresponding to the sensor data) is requested by a first application (e.g., a first process, such as a user process). In some examples, the third set of one or more criteria includes a criterion that is satisfied when sensor information is requested by a second application (e.g., a second process, such as a user process) different from the first application. In some examples, the second application is a different type of application (e.g., an application with different features, settings, permissions, rights, and/or configurations) than the first application. In some examples, the second metadata is a different (e.g., lower or higher) fidelity and/or resolution from the metadata such that the system process does not receive all and/or most of the information provided by the metadata when receiving the second metadata instead of the metadata.

In some examples, the secure process of the device determines (e.g., generates, computes, identifies, and/or obtains) (e.g., by the secure process) (e.g., before forgoing sending the sensor data to the system process and/or before sending the metadata corresponding to the sensor data) (e.g., after receiving a request, from the system process, for the sensor data) (e.g., in response to receiving the sensor data) the metadata using the sensor data. In some examples, the secure process determines the metadata by performing one or more operations (e.g., a comparison operation and/or a mathematical operation) on the sensor data.

In some examples, the metadata indicates whether an event occurred with respect to the sensor data (e.g., whether the sensor data satisfies a predefined threshold and/or includes a predefined attribute and/or characteristic). In some examples, the sensor data includes an image, and the metadata indicates whether the image includes a particular object (e.g., an identified type of object or a predefined object). In some examples, the sensor data includes audio, and the metadata indicates whether the audio includes a predefined utterance. In some examples, the sensor data includes a value of health data, and the metadata indicates whether the value exceeds a predefined threshold.

In some examples, the secure process includes a first detection mechanism (e.g., specialized hardware and/or an instance of code executing that corresponds to a first set of one or more features) and a second detection mechanism (e.g., specialized hardware and/or an instance of code executing that corresponds to a first set of one or more features) different from the first detection mechanism. In some examples, the first detection mechanism produces (e.g., identifies, determines, and/or generates) a first type of metadata (e.g., to be sent to the system process). In some examples, the second detection mechanism produces (e.g., identifies, determines, and/or generates) a second type of metadata (e.g., to be sent to the system process) different from the first type of metadata. In some examples, the first detection mechanism and the second detection mechanism execute at least partially in parallel. In some examples, the first detection mechanism produces the metadata and the second detection mechanism produces the second metadata. In some examples, a portion of the metadata and a portion of the second metadata is produced in parallel. In some examples, the first detection mechanism produces the metadata and the second metadata. In some examples, the second detection mechanism produces metadata different from the metadata and the second metadata. In some examples, the first detection mechanism produces respective metadata (e.g., the metadata and/or the second metadata) using respective sensor data (e.g., the sensor data).

In some examples, the first detection mechanism uses (e.g., computes, generates, determines and/or provides metadata corresponding to) sensor data from a first type of sensor. In some examples, the second detection mechanism uses (e.g., computes, generates, determines and/or provides metadata corresponding to) sensor data from a second type of sensor different from the first type of sensor. In some examples, the first type of sensor produces a different type of sensor data than the second type of sensor.

In some examples, the first detection mechanism and the second detection mechanism use (e.g., compute, generate, determine and/or provide metadata corresponding to) the sensor data to produce respective metadata (e.g., and, in some examples, the first detection mechanism uses respective sensor data from a respective sensor, and the second detection mechanism uses the respective sensor data from the respective sensor).

In some examples, after receiving the sensor data and in accordance with a determination that a fourth set of one or more criteria is satisfied (e.g., and/or that the first set of one or more criteria and/or the second set of one or more criteria is not satisfied), the secure process of the device forgoes sending sensor information corresponding to the sensor data (e.g., respective sensor data and/or metadata corresponding to the respective sensor data) to the system process (e.g., as a result of the fourth set of one or more criteria being satisfied) (e.g., the sensor information (e.g., the sensor data) would be sent to the system process as a result of the first set of one or more criteria being satisfied) (e.g., the sensor information (e.g., the metadata corresponding to the sensor data) would be sent to the system process as a result of the second set of one or more criteria being satisfied).

In some examples, the sensor data is sent, from a first application (e.g., a first user and/or non-system process) (e.g., different from the secure process and the system process) executing on the device, to the system process to satisfy a request for sensor information received by the system process from the first application. In some examples, the secure process of the device receives, from a second sensor (e.g., the sensor or another sensor different from the sensor) in communication with the secure process, second sensor data (e.g., the same type of sensor data as the sensor data or a different type of sensor data than the sensor data). In some examples, after receiving the second sensor data and in accordance with a determination that the first set of one or more criteria is satisfied (e.g., and/or, in some examples, that the second set of criteria is not satisfied), the secure process of the device sends the second sensor data to the system process. In some examples, the second sensor data is sent to the system process to satisfy a request for sensor information received by the system process from a second application executing on the device. In some examples, the second application is different from the first application. In some examples, the second sensor data is sent to the system process in response to the secure process receiving a second respective request for sensor information from the system process, the second respective request corresponding to the request for sensor information received by the system process from the second application. In some examples, the second sensor data is sent separately for each application (e.g., the first application, the second application, and/or a different application). In some examples, one instance of the second sensor data is sent for all and/or most applications (e.g., the first application, the second application, and/or a different application) currently requesting the sensor data and satisfying criteria described above. In some examples, after receiving the second sensor data and in accordance with a determination that the second set of one or more criteria is satisfied (e.g., and, in some examples, that the first set of criteria is not satisfied), the secure process of the device forgoes sending the second sensor data to the system process of the device. In some examples, after receiving the second sensor data and in accordance with a determination that the device is in the second state, the secure process forgoes sending the second sensor data anywhere (e.g., to any other process) and instead stores or deletes the second sensor data from memory corresponding to the secure process.

In some examples, the secure process of the device receives, from a third sensor (e.g., the sensor and/or another sensor different from the sensor) in communication with the secure process, third sensor data (e.g., the sensor data and/or another sensor data different from the sensor data). In some examples, after receiving the third sensor data and in accordance with a determination that a fifth set of one or more criteria is satisfied, wherein the fifth set of one or more criteria includes a criterion corresponding to a type of sensor data corresponding to the third sensor data, and wherein the fifth set of one or more criteria does not include a criterion that is based on a state (e.g., a current or previous state) of the device, the secure process of the device sends, to the system process, sensor information (e.g., the third sensor data and/or metadata corresponding to the third sensor data) (e.g., non-critical sensor data or non-critical metadata corresponding to the third sensor data) corresponding to the third sensor data. In some examples, the sensor information is sent to the system process regardless of whether the device is in the first state or the second state. In some examples, the first set, the second set, the third set, and/or the fourth set of one or more criteria does not include a criterion corresponding to the type of sensor data corresponding to the third sensor data. In some examples, the fifth set of one or more criteria is satisfied based on (e.g., solely, primarily, and/or as a result of) the type of sensor data corresponding to the third sensor data. In some examples, the first set, the second set, the third set, and/or the fourth set of one or more criteria is not satisfied based on (e.g., solely, primarily, and/or as a result of) the type of sensor data corresponding to the third sensor data.

In some examples, after receiving the sensor data and in accordance with a determination that a sixth set of one or more criteria is satisfied, the secure process of the device sends, to the system process, fourth sensor data (e.g., sensor data that is determined, generated, and/or identified from the sensor data) corresponding to the sensor data, wherein the fourth sensor data is different from the sensor data (e.g., and the metadata). In some examples, the sixth set of one or more criteria includes a criterion that is satisfied when a determination is made that the device is in the first state. In some examples, the sixth set of one or more criteria includes a criterion that is satisfied when a determination is made that the device is in a third state different from the first state and the second state. In some examples, the sixth set of one or more criteria includes a criterion that is satisfied when sensor information (e.g., sensor data and/or metadata corresponding to the sensor data) is requested by the first application (e.g., and/or a particular type of application). In some examples, the fourth sensor data is at a different resolution (e.g., lesser, reduced, and/or higher resolution) than the sensor data. In some examples, the fourth sensor data is a version of the sensor data at a reduced resolution.

In some examples, after sending the sensor data to the system process, the secure process of the device receives, from the sensor, fifth sensor data. In some examples, after receiving the fifth sensor data and in accordance with a determination that the second set of one or more criteria is satisfied, the secure process of the device sends sensor information (e.g., the fifth sensor data and/or metadata corresponding to the fifth sensor data) to the system process. In some examples, the sensor information is sent to the system process as a result of the device being in the second state instead of the first state. In some examples, after forgoing sending the sensor data to the system process (and/or sending the fifth sensor data), the secure process receives, from the sensor, sixth sensor data. In some examples, after receiving the fifth sensor data and in accordance with a determination that the first set of one or more criteria is satisfied, sending the fifth sensor data to the system process. In some examples, the fifth sensor data is sent to the system process as a result of the device being in the first state. In some examples, the sensor data includes health, video, and/or audio data.

In some examples, the first state corresponds to the device displaying an indication that respective sensor data (e.g., sensor data of a particular type and/or sensor data at all) is being provided to an application (e.g., a user and/or non-system application different from the secure process and the system process) (e.g., a particular application and/or any non-system application at all) (e.g., and/or is being captured). In some examples, the second state corresponds to the device not (e.g., and/or forgoing) displaying an indication that sensor data is being provided to an application (e.g., and/or is being captured).

In some examples, the system process is part of an operating system (e.g., a primary and/or main operating system) of the device. In some examples, the secure process executes using a microkernel separate from a kernel used by the system process.

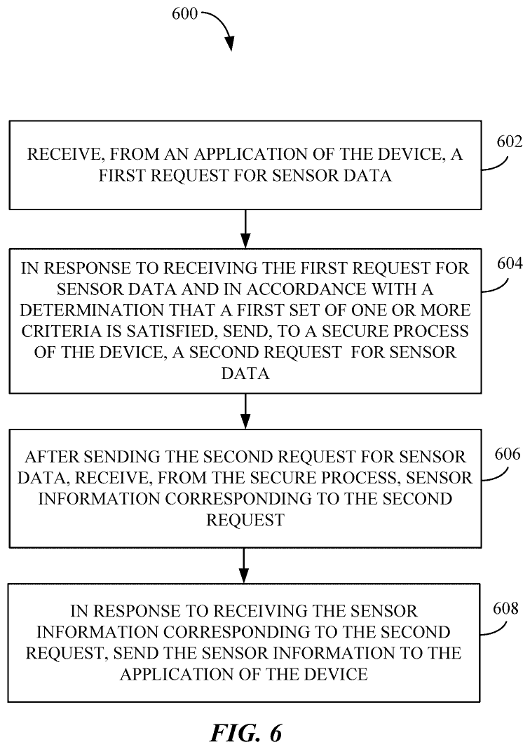

Note that details of the processes described above with respect to method 500 (e.g., FIG. 5) are also applicable in an analogous manner to other methods described herein. For example, method 600 optionally includes one or more of the characteristics of the various methods described above with reference to method 500. For example, the system process of FIG. 5 can be the system process of FIG. 6. For brevity, these details are not repeated below.

FIG. 6 is a flow diagram illustrating a method (e.g., method 600) for a system process to filter sensor data in accordance with some examples. Some operations in method 600 are, optionally, combined, the orders of some operations are, optionally, changed, and some operations are, optionally, omitted.

In some examples, method 600 is performed by a system process (e.g., as described above with respect to method 500) of a device (e.g., as described above with respect to method 500). In some examples, the system process is executed by a CPU of the device. In some examples, the system process is executed by a processor executing a user application and/or a secure process (as described above with respect to method 500) of the device. In some examples, data corresponding to the system process is stored in memory that also stores data unrelated to the system process.

At 602, the system process receives, from an application (e.g., a user application, an application executing in user space, and/or an application separate from a system (e.g., an operating system)) (e.g., applications 306 and/or application 420) of the device, a first request for sensor data (e.g., as described above with respect to method 500). In some examples, the first request includes an indication of a sensor (e.g., as described above with respect to method 500) of the device (e.g., a sensor that is in communication with the device). In some examples, the first request includes a type of sensor data, in which case the system process identifies a sensor corresponding to the first request.

At 604, in response to receiving the first request for sensor data and in accordance with a determination that a first set of one or more criteria is satisfied, wherein the first set of one or more criteria includes a criterion that is satisfied when (e.g., while) the device is in a first state (e.g., as described above with respect to method 500), the system process sends, to a secure process (e.g., as described above with respect to method 500) of the device, a second request (e.g., the first request or a different request based on the first request) for sensor data (e.g., as described above with respect to method 500). In some examples, in response to receiving the first request for sensor data and in accordance with a determination that (e.g., while) the device is in a second state different from the first state, the system process forgoes sending, to the secure process of the device, the second request for sensor data.

At 606, after (e.g., directly after, in response to, in conjunction with, immediately after, and/or as a response to) sending the second request for sensor data, the system process receives, from the secure process, sensor information (e.g., first sensor data (such as raw sensor data from a sensor) or metadata (e.g., as described above with respect to method 500) corresponding to the first sensor data) corresponding to the second request.

At 608, in response to receiving the sensor information corresponding to the second request, the system process sends the sensor information to the application of the device (e.g., as a response to the first request).

In some examples, the system process determines (e.g., before receiving the sensor data, before sending the second request) the state of the device. In some examples, the system process determines the state of the device by sending a request to a second system process (e.g., different from the system process) of the device for a current state of the operating system. In some examples, an operating system of the device includes the system process and/or the second system process. In some examples, the system process determines the state of the device by accessing memory of the device.

In some examples, in response to receiving the first request for sensor data and in accordance with a determination a second set of one or more criteria is satisfied, wherein the second set of one or more criteria is different from the first set of one or more criteria, the system process sends (e.g., to a sensor corresponding to the sensor data instead of the secure process) a third request (e.g., the second request or a different request based on the first request) for sensor data without sending the second request to the secure process. In some examples, the second set of one or more criteria includes a criterion that is satisfied when a determination is made that the sensor and/or the sensor data corresponds to a particular type of sensor (e.g., a sensor not protected by the secure process) and/or sensor data (e.g., non-critical and/or non-protected sensor data) respectively.

In some examples, in response to receiving the first request for sensor data and in accordance with a determination a third set of one or more criteria is satisfied, wherein the third set of one or more criteria is different from the first set of one or more criteria (e.g., and/or the second set of one or more criteria), the system process rejects the first request (e.g., and/or forgoing sending the second request to the secure process). In some examples, the third set of one or more criteria includes a criterion based on a type of the application. In some examples, the third set of one or more criteria includes a criterion that is satisfied when (e.g., while and/or after) the device is in a second state different from the first state. In some examples, in response to receiving the first request for sensor data and in accordance with a determination the third set of one or more criteria is satisfied, the system process sends, to the application, a notification that the first request has been rejected (e.g., without sending a request to the secure process and/or without sending sensor information to the application).

In some examples, after receiving the first request, the system process sends a request to change the device (e.g., the system process attempts to cause the device to change) from a respective state (e.g., the second state or another state different from the first and second state) to the first state. In some examples, after the request to change the device is successful, the criterion of the first set of one or more criteria is satisfied. In some examples, after the request to change the device is not successful, the criterion of the first set of one or more criteria is not satisfied. In some examples, the request to change the device to the first state is sent in response to a determination that the device is in a state different from the first state (e.g., the respective state). In some examples, the request to change the device to the first state is sent in response to receiving the first request.

In some examples, after sending the second request for sensor data, the system process receives, from the application, a fourth request for sensor data. In some examples, in response to receiving the fourth request and in accordance with a determination that a fourth set of one or more criteria is satisfied, wherein the fourth set of one or more criteria is different from the first set of one or more criteria (and, in some examples, the second and/or the third set of one or more criteria), the system process sends, to the secure process, a fifth request for sensor data. In some examples, after sending the fifth request for sensor data, the system process receives, from the secure process, second sensor information corresponding to the fifth request. In some examples, the sensor information is a first type of sensor information. In some examples, the second sensor information is a second type of sensor information (e.g., a different resolution of sensor data, sensor data or metadata, or a different level of detail of metadata) different from the sensor information. In some examples, in response to receiving the second sensor information, the system process sends the second sensor information to the application of the device. In some examples, the second sensor information is sent to the system process as a result of the device being in the third state instead of the first state.

In some examples, the first request corresponds to health, video, or audio data (e.g., the sensor information corresponds to and/or includes health, video, and/or audio data) (e.g., the sensor data corresponds to health, video, and/or audio data).

In some examples, the sensor information includes metadata corresponding to the sensor data. In some examples, the metadata indicates whether an event has occurred with respect to the sensor data (e.g., whether the sensor data satisfies a predefined threshold and/or includes a predefined attribute and/or characteristic). In some examples, the sensor data includes an image, and the metadata indicates whether the image includes a particular object (e.g., an identified type of object or a predefined object). In some examples, the sensor data includes audio, and the metadata indicates whether the audio includes a predefined utterance. In some examples, the sensor data includes a value of health data, and the metadata indicates whether the value exceeds a predefined threshold.

In some examples, the first state corresponds to the device displaying an indication that the sensor data is being provided to an application (e.g., and/or is being captured). In some examples, the second state corresponds to the device not displaying (e.g., and/or forgoing displaying) an indication that the sensor data is being provided to an application (e.g., and/or is being captured). In some examples, the second state does not correspond to the device displaying the indication that the sensor data is being provided to the application.

In some examples, the system process is part of an operating system (e.g., a main and/or primary operating system) of the device. In some examples, the secure process executes using (and/or via) a microkernel separate from a kernel used by the system process.

Note that details of the processes described above with respect to method 600 (e.g., FIG. 6) are also applicable in an analogous manner to other methods described herein. For example, method 500 optionally includes one or more of the characteristics of the various methods described above with reference to method 600. For example, the secure process of FIG. 6 can be the secure process of FIG. 5. For brevity, these details are not repeated below.

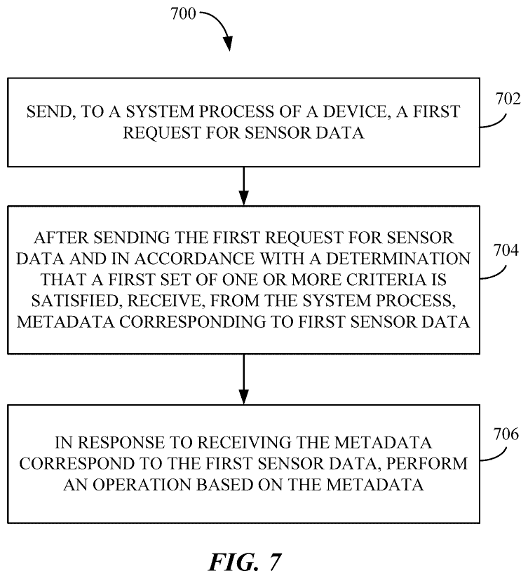

FIG. 7 is a flow diagram illustrating a method (e.g., method 700) for an application to request sensor data in accordance with some examples. Some operations in method 700 are, optionally, combined, the orders of some operations are, optionally, changed, and some operations are, optionally, omitted.

In some examples, method 700 is performed by an application (e.g., as described above with respect to method 600) of a device (e.g., as described above with respect to method 500 and/or method 600). In some examples, the application is executed by a CPU of the device. In some examples, the application is executed by a processor executing a system process (as described above with respect to method 500) and/or a secure process (as described above with respect to method 500) of the device. In some examples, data corresponding to the application is stored in memory that also stores data unrelated to the application.

At 702, the application of the device sends, to a system process (e.g., as described above with respect to method 500 and/or method 600) of the device, a first request for sensor data (e.g., as described above with respect to method 500 and/or method 600). In some examples, the first request includes an indication of a sensor (e.g., a microphone, a camera, a heartrate monitor, a pedometer, and/or a gyroscope) of the device (e.g., a sensor that is in communication with the device). In some examples, the first request includes a type of sensor data and, based on the first request identifying the type of sensor data and not identifying a particular sensor, the system process identifies a sensor corresponding to the first request.

At 704, after (e.g., directly after, in response to, in conjunction with, immediately after, and/or as a response to) sending the first request for sensor data and in accordance with a determination that a first set of one or more criteria is satisfied (e.g., as described above with respect to the second set of one or more criteria of method 500 and/or method 600), the application of the device receives, from the system process, metadata (e.g., as described above with respect to method 500 and/or method 600) corresponding to first sensor data, wherein the metadata corresponds to the second request (and, in some examples, not the first request), wherein the metadata is based on the first sensor data, wherein the first sensor data is accessible to a secure process (e.g., as described above with respect to method 500 and/or method 600) of the device, and wherein the first sensor data is not accessible to (e.g., not directly accessibly by, not readable by, and/or prevented from access by) (e.g., not readily (e.g., without permission, without sending a request) accessibly by, cannot readily be acquired and/or obtained by, cannot readily be read, updated, and/or deleted by, and/or cannot be readily be detected by) the system process (e.g., such as when and/or when a determination is made that the device is in the first state) (e.g., such as when and/or when a determination is made that the system process never has access to the first sensor data and only ever has access to metadata corresponding to the first sensor data, even when and/or when a determination is made that the device is in a first state as described above with respect to method 500 and/or method 600).

At 706, in response to receiving the metadata corresponding to the first sensor data, the application of the device performs an operation (e.g., a calculation, a determination, an identification, and/or a display (e.g., of the metadata and/or of data associated with the metadata)) based on (and, in some examples, using) the metadata. In some examples, performing the operation includes displaying (e.g., via a display and/or a display generation component) the metadata.

In some examples, after sending the first request for sensor data and in accordance with a determination that a second set of one or more criteria is satisfied (e.g., as described above with respect to method 500 and/or method 600), wherein the second set of one or more criteria is different from the first set of one or more criteria, the application of the device receives, from the system process, the first sensor data. In some examples, in response to receiving the first sensor data, the application of the device performs a second operation (e.g., a calculation, a determination, an identification, and/or a display (e.g., of the metadata and/or of data associated with the metadata)) based on (and, in some examples, using) the first sensor data, wherein the second operation is different from the operation. In some examples, the second operation is a different type of operation (e.g., display information as opposed to send a request for additional information) than the operation. In some examples, the second operation is the same type of operation (e.g., both display information) as the operation but with different data. In some examples, the second operation is a different type of display than the operation. In some examples, the first sensor data includes, health, video, audio data, or any combination thereof.

In some examples, the metadata indicates whether an event has occurred with respect to the first sensor data (e.g., whether the first sensor data satisfies a predefined threshold and/or includes a predefined attribute and/or characteristic). In some examples, the first sensor data includes an image, and the metadata indicates whether the image includes a particular object (e.g., an identified type of object or a predefined object). In some examples, the first sensor data includes audio, and the metadata indicates whether the audio includes a predefined utterance. In some examples, the first sensor data includes a value of health data, and the metadata indicates whether the value exceeds a predefined threshold.

In some examples, the system process is part of an operating system (e.g., a main and/or primary operating system) of the device. In some examples, the secure process executes using (and/or via) a microkernel separate from a kernel used by the system process.

In some examples, after sending the first request for sensor data, the application of the device sends, to the system process, a second request for sensor data, wherein the second request is the same type of request as the first request. In some examples, the second request is the same as the first request. In some examples, after sending the second request for sensor data and in accordance with a determination that a second set of one or more criteria is satisfied (e.g., as described above with respect to the first set of one or more criteria of method 500 and/or method 600), the application of the device receives, from the system process, second sensor data. In some examples, the second sensor data is a different type of data than the metadata. In some examples, in response to receiving the second sensor data, the application of the device performs a third operation (e.g., a calculation, a determination, an identification, and/or a display (e.g., of the metadata and/or of data associated with the metadata)) based on (and, in some examples, using) the second sensor data.

Note that details of the processes described above with respect to method 700 (e.g., FIG. 7) are also applicable in an analogous manner to the methods described herein. For example, method 500 and/or method 600 optionally includes one or more of the characteristics of the various methods described above with reference to method 700. For example, the application of FIG. 5 and/or the application of FIG. 6 can be the application of FIG. 7. For brevity, these details are not repeated below.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how a device handles data. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a device filters sensor data. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, content can be displayed to users by inferring sensor data based on non-personal information data or a bare minimum amount of personal information, such as the content being requested by the device associated with a user or other non-personal information.

What is claimed is:

1. A method, comprising:
by a secure process of a device:
receiving, from a sensor in communication with a secure process, sensor data; and
after receiving the sensor data:
in accordance with a determination that a first set of one or more criteria is satisfied, wherein the first set of one or more criteria includes a criterion that is satisfied when the device is currently in a first state, sending the sensor data to a system process of the device; and
in accordance with a determination that a second set of one or more criteria is satisfied, wherein the second set of one or more criteria includes a criterion that is satisfied when the device is currently in a second state different from the first state, forgoing sending the sensor data to the system process of the device, wherein the second set of one or more criteria is different from the first set of one or more criteria.

2. The method of claim 1, further comprising:
determining a current state of the device.

3. The method of claim 2, further comprising:
in response to determining the current state of the device, sending a request to change the device from a respective state to the first state.

4. The method of claim 1, further comprising:
after receiving the sensor data and in accordance with a determination that the second set of one or more criteria is satisfied, sending, to the system process, metadata corresponding to the sensor data, wherein the metadata is different from the sensor data.

5. The method of claim 4, further comprising:
after receiving the sensor data and in accordance with a determination that a third set of one or more criteria is satisfied, sending, to the system process, second metadata corresponding to the sensor data, wherein the second metadata is different from the sensor data and the metadata.

6. The method of claim 4, further comprising:
determining the metadata using the sensor data.

7. The method of claim 4, wherein the metadata indicates whether an event occurred with respect to the sensor data.

8. The method of claim 4, wherein the secure process includes a first detection mechanism and a second detection mechanism different from the first detection mechanism, wherein the first detection mechanism produces a first type of metadata, and wherein the second detection mechanism produces a second type of metadata different from the first type of metadata.

9. The method of claim 8, wherein the first detection mechanism uses sensor data from a first type of sensor, and wherein the second detection mechanism uses sensor data from a second type of sensor different from the first type of sensor.

10. The method of claim 8, wherein the first detection mechanism and the second detection mechanism uses the sensor data to produce respective metadata.

11. The method of claim 1, further comprising:
after receiving the sensor data and in accordance with a determination that a fourth set of one or more criteria is satisfied, forgoing sending sensor information corresponding to the sensor data to the system process.

12. The method of claim 1, wherein the sensor data is sent, from a first application executing on the device, to the system process to satisfy a request for sensor information received by the system process from the first application, the method further comprising:
receiving, from a second sensor in communication with the secure process, second sensor data; and
after receiving the second sensor data:
in accordance with a determination that the first set of one or more criteria is satisfied, sending the second sensor data to the system process, wherein the second sensor data is sent to the system process to satisfy a request for sensor information received by the system process from a second application executing on the device, and wherein the second application is different from the first application; and
in accordance with a determination that the second set of one or more criteria is satisfied, forgoing sending the second sensor data to the system process of the device.

13. The method of claim 1, further comprising:
receiving, from a third sensor in communication with the secure process, third sensor data; and
after receiving the third sensor data and in accordance with a determination that a fifth set of one or more criteria is satisfied, wherein the fifth set of one or more criteria includes a criterion corresponding to a type of sensor data corresponding to the third sensor data, and wherein the fifth set of one or more criteria does not include a criterion that is based on a state of the device, sending, to the system process, sensor information corresponding to the third sensor data.

14. The method of claim 1, further comprising:
after receiving the sensor data and in accordance with a determination that a sixth set of one or more criteria is satisfied, sending, to the system process, fourth sensor data corresponding to the sensor data, wherein the fourth sensor data is different from the sensor data.

15. The method of claim 1, further comprising:
after sending the sensor data to the system process, receiving, from the sensor, fifth sensor data; and
after receiving the fifth sensor data and in accordance with a determination that the second set of one or more criteria is satisfied, sending sensor information to the system process.

16. The method of claim 1, wherein the sensor data includes health, video, and/or audio data.

17. The method of claim 1, wherein the first state corresponds to the device displaying an indication that respective sensor data is being provided to an application, and wherein the second state corresponds to the device not displaying an indication that sensor data is being provided to an application.

18. The method of claim 1, wherein the system process is part of an operating system of the device.

19. The method of claim 1, wherein the secure process executes using a microkernel separate from a kernel used by the system process.

20. A non-transitory computer-readable storage medium storing one or more programs configured to be executed by one or more processors of a device, the one or more programs including instructions for:
receiving, from a sensor in communication with a secure process, sensor data; and
after receiving the sensor data:
in accordance with a determination that a first set of one or more criteria is satisfied, wherein the first set of one or more criteria includes a criterion that is satisfied when the device is currently in a first state, sending the sensor data to a system process of the device; and
in accordance with a determination that a second set of one or more criteria is satisfied, wherein the second set of one or more criteria includes a criterion that is satisfied when the device is currently in a second state different from the first state, forgoing sending the sensor data to the system process of the device, wherein the second set of one or more criteria is different from the first set of one or more criteria.

21. A device, comprising:
one or more processors; and
memory storing one or more programs configured to be executed by the one or more processors, the one or more programs including instructions for:
receiving, from a sensor in communication with a secure process, sensor data; and
after receiving the sensor data:
in accordance with a determination that a first set of one or more criteria is satisfied, wherein the first set of one or more criteria includes a criterion that is satisfied when the device is currently in a first state, sending the sensor data to a system process of the device; and
in accordance with a determination that a second set of one or more criteria is satisfied, wherein the second set of one or more criteria includes a criterion that is satisfied when the device is currently in a second state different from the first state, forgoing sending the sensor data to the system process of the device, wherein the second set of one or more criteria is different from the first set of one or more criteria.
